(19) United States
(12) Patent Application Publication
(10) Pub. No.: US 2006/0075142 A1
(43) Pub. Date: Apr. 6, 2006

(54) Storing packet headers

(76) Inventors: Linden Cornett, Portland, OR (US); David B. Minturn, Hillsboro, OR (US); Sujoy Sen, Portland, OR (US); Anil Vasudevan, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/954,248

(22) Filed: Sep. 29, 2004

(51) Int. Cl. G06F 15/16

(52) U.S. Cl. 709/246

(57) ABSTRACT

In general, in one aspect, the disclosure describes a method that includes causing the header of a packet to be stored in a set of at least one page of memory allocated to storing packet headers and causing the packet to be stored in a location not in the set.

### BACKGROUND

Networks enable computers and other devices to communicate. For example, networks can carry data representing video, audio, e-mail, and so forth. Typically, data sent across a network is carried within smaller messages known as packets. By analogy, a packet is much like an envelope you drop in a mailbox. A packet typically includes “payload” and a “header”. The packet's “payload” is analogous to the letter inside the envelope. The packet's “header” is much like the information written on the envelope itself. The header can include information to help network devices handle the packet appropriately.

A number of network protocols cooperate to handle the complexity of network communication. For example, a transport protocol known as Transmission Control Protocol (TCP) provides “connection” services that enable remote applications to communicate. TCP provides applications with simple mechanisms for establishing a connection and transferring data across a network. Behind the scenes, TCP handles a variety of communication issues such as data retransmission, adapting to network traffic congestion, and so forth.

To provide these services, TCP operates on packets known as segments. Generally, a TCP segment travels across a network within (“encapsulated” by) a larger packet such as an Internet Protocol (IP) datagram. Frequently, an IP datagram is further encapsulated by an even larger packet such as an Ethernet frame. The payload of a TCP segment carries a portion of a stream of data sent across a network by an application. A receiver can restore the original stream of data by reassembling the received segments. To permit reassembly and acknowledgment (ACK) of received data back to the sender, TCP associates a sequence number with each payload byte.

Many computer systems and other devices feature host processors (e.g., general purpose Central Processing Units (CPUs)) that handle a wide variety of computing tasks. Often these tasks include handling network traffic such as TCP/IP connections.

The increases in network traffic and connection speeds have increased the burden of packet processing on host systems. In short, more packets need to be processed in less time. Fortunately, processor speeds have continued to increase, partially absorbing these increased demands. Improvements in the speed of memory, however, have generally failed to keep pace. Each memory access that occurs during packet processing represents a potential delay as the processor awaits completion of the memory operation. Many network protocol implementations access memory a number of times for each packet. For example, a typical TCP/IP implementation accesses the header to perform operations such as determining the packet's connection, segment reassembly, generating acknowledgments (ACKs), and so forth. To speed memory operations, many processors feature a cache that can make a small set of data more quickly accessible than in memory.

### BRIEF DESCRIPTION OF THE DRAWINGS

FIGS. 1A-1D illustrate storage of packet headers.

FIG. 2 is a flow-chart of a process to store packet headers.

FIG. 3 is a flow-chart of a process to prefetch packet headers into a cache.

FIG. 4 is a diagram of a computer system.

### DETAILED DESCRIPTION

As described above, each memory operation that occurs during packet processing represents a potential delay. Given that reading a packet header occurs for nearly every packet, storing the header in a processor's cache can greatly improve packet processing speed. Generally, however, a given packet's header will not be in cache when the stack first attempts to read the header. For example, in many systems, a network interface controller (NIC) receiving a packet writes the packet into memory and signals an interrupt to a processor. In this scenario, the protocol software's initial attempt to read the packet's header results in a “compulsory” cache miss and an ensuing delay as the packet header is retrieved from memory.

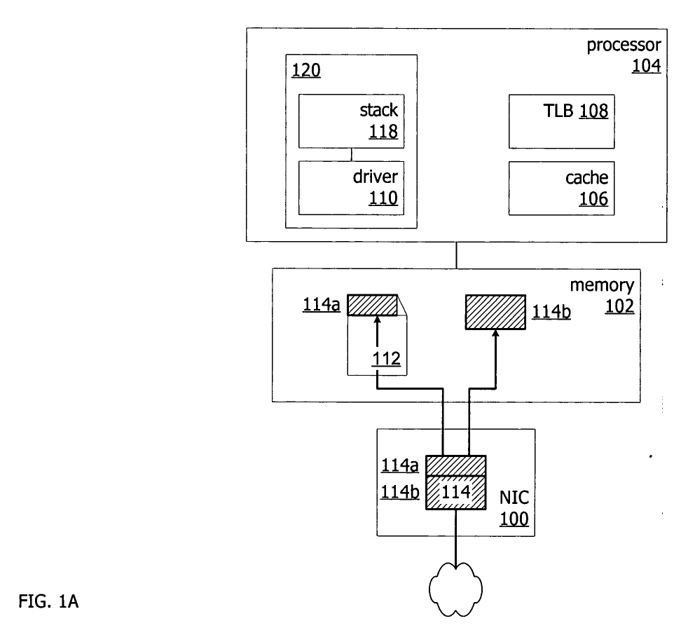

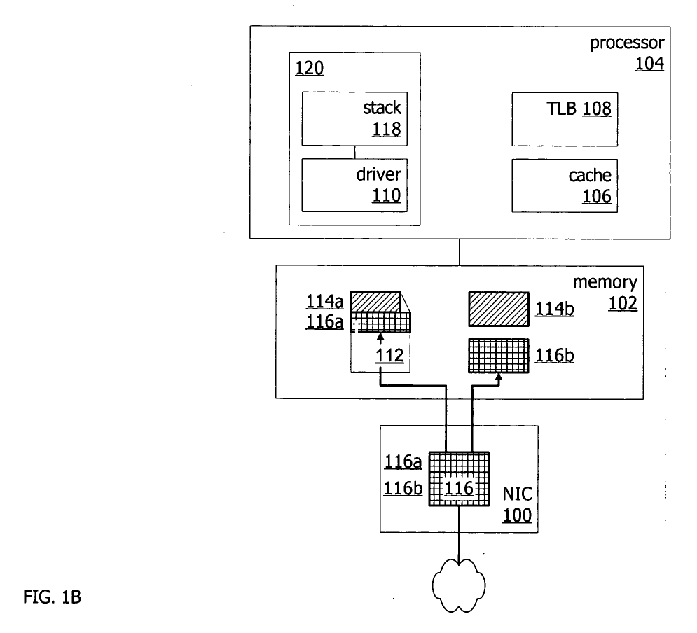

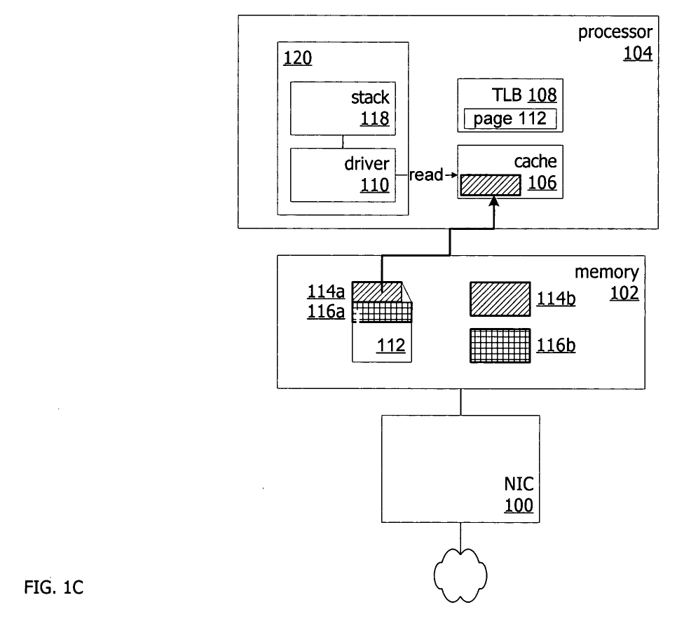

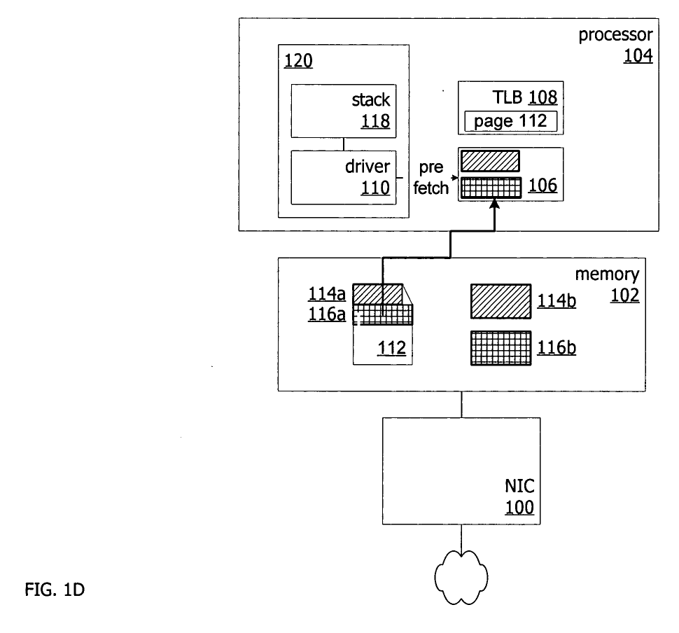

FIGS. 1A-1D illustrate techniques that can increase the likelihood that a given packet's header will be in a processor's cache when needed by collecting packet headers into a relatively small set of memory pages. By splitting a packet apart and excluding packet payloads from these pages, a larger number of headers can be concentrated together. This reduced set of pages can then be managed in a way to permit effective prefetching of packet headers into the processor cache before the protocol stack processes the header.

In greater detail, FIG. 1A depicts a sample computer system that features a processor 104, memory 102, and a network interface controller 100. Memory 102 is organized as a collection of physical pages of contiguous memory addresses. The size of a page may vary in different implementations.

In this sample system, the processor 104 includes a cache 106 and a Translation Lookaside Buffer (TLB) 108. Briefly, many systems provide a virtual address space that greatly exceeds the available physical memory. The TLB 108 is a table that cross-references between virtual page addresses and the currently mapped physical page addresses for recently referenced pages of memory. When a request for a virtual address results in a cache miss, the TLB 108 is used to translate the virtual address into a physical memory address. However, if a given page is not in the TLB 108 (e.g., a page not having been accessed in some time), a delay is incurred in performing address translation while the physical address is determined.

As shown, the processor 104 also executes instructions of a driver 120 that includes a protocol stack 118 (e.g., a TCP/IP protocol stack) and a base driver 110 that controls and configures operation of network interface controller 100. Potentially, the base driver 110 and stack 118 may be implemented as different layers of an NDIS (Microsoft Network Driver Interface Specification) compliant driver 120 (e.g., an NDIS 6.0 compliant driver).

As shown in FIG. 1A, in operation the network interface controller 100 receives a packet 114 from a network (shown as a cloud). As shown, the controller 100 can “split” the packet 114 into its constituent header 114a and payload 114b. For example, the controller 100 can determine the starting address and length of a packet's 114 TCP/IP header 114a and starting address and length of the packet's 114 payload 114b. Instead of simply writing a verbatim, contiguous copy of the packet 114 into memory 102, the controller 100 can cause the packet components 114a, 114b to be stored separately. For example, as shown, the controller 100 can write the packet's header 114a into a physical page 112 of memory 102 used for storage of packet headers, while the packet payload 114b is written into a different location (e.g., a location not contiguous or in the same page as the location of the packet's header 114a).

As shown in FIG. 1B, this process can repeat for subsequently received packets. That is, for received packet 116, the controller 100 can append the packet's header 116a to the headers stored in page 112 and write the packet's payload 116b to a separate location somewhere else in memory 102.

To avoid an initial cache miss, a packet's header may be prefetched into cache 106 before header processing by stack 118 software. For example, driver 110 may execute a prefetch instruction that loads a packet header from memory 102 into cache 106. As described above, in some architectures, the efficiency of a prefetch instruction suffers when a memory access falls within a page not currently identified in the processor's 104 TLB 108. By compactly storing the headers of different packets within a relatively small number of pages, these pages can be maintained in the TLB 108 without occupying an excessive number of TLB entries. For example, when stripped of their corresponding payloads, 32 different 128-byte headers can be stored in a single 4-kilobyte page instead of one or two packets stored in their entirety.

As shown in FIG. 1C, the page(s) 112 storing headers can be maintained in the TLB 108, for example, by a memory access (e.g., a read) to a location in the page. This “touch” of a page may be repeated at different times to ensure that a page is in the TLB 108 before a prefetch. For example, a read of a page may be performed each time an initial entry in a page of headers is written. Assuming that packet headers are stored in page 112 in the order received, performing a memory operation for the first entry will likely keep the page 112 in the TLB 108 for the subsequently added headers.

As shown in FIG. 1D, once included in the TLB 108, prefetch operations load the header(s) stored in the page(s) 112 into the processor 104 cache 106 without additional delay. For example, as shown, the base driver 110 can prefetch the header 116a for packet 116 before TCP processing of the header by the protocol stack 118.

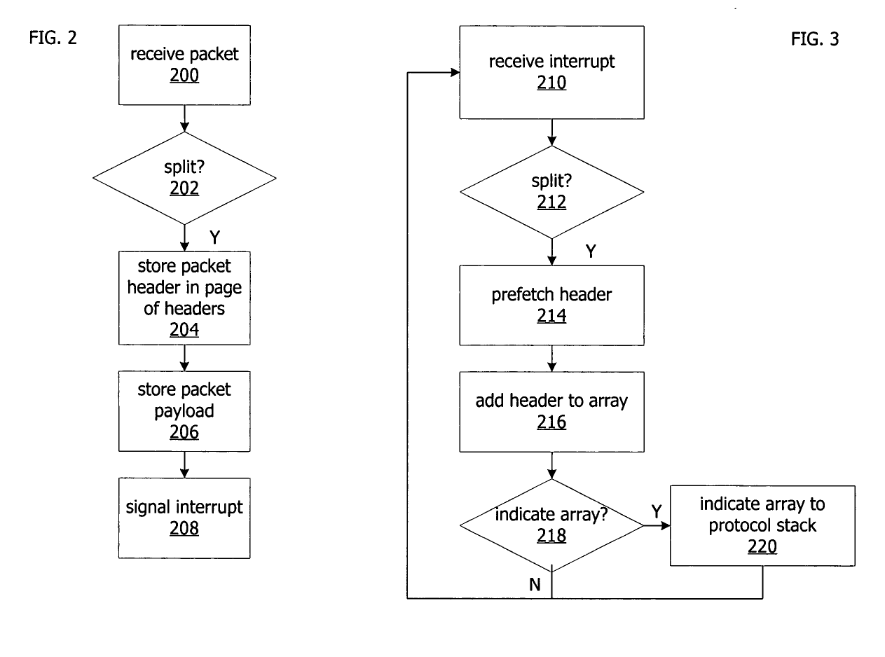

FIG. 2 illustrates sample operation of a network interface controller participating in the scheme described above. As shown, after receiving 200 a packet, the controller can determine 202 whether to perform header splitting. For example, the controller may only perform splitting for TCP/IP packets or packets belonging to particular flows (e.g., particular TCP/IP connections or Asynchronous Transfer Mode (ATM) circuits).

For packets selected for splitting, the controller can cause storage 204 (e.g., via Direct Memory Access (DMA)) of the packet's header in the page(s) used to store headers and separately store 206 the packet's payload. For example, the controller may consume a packet descriptor from memory generated by the driver that identifies an address to use to store the payload and a different address to use to store the header. The driver may generate and enqueue these descriptors in memory such that a series of packet headers are consecutively stored one after the other in the header page(s). For instance, the driver may enqueue a descriptor identifying the start of page 112 for the first packet header received (e.g., packet header 114b in FIG. 1A) and enqueue a second descriptor identifying the following portion of page 112 for the next packet header (e.g., packet header 116b in FIG. 1B). Alternately, the controller may maintain pointers into the set of pages 112 to store headers, essentially using the pages as a ring buffer for received headers.

As shown, after writing the header, the controller signals 208 an interrupt to the driver indicating receipt of a packet. Potentially, the controller may implement an interrupt moderation scheme and signal an interrupt after some period of time and/or the receipt of multiple packets.

FIG. 3 illustrates sample operation of the driver in this scheme. As shown, after receiving 210 an interrupt for a split packet 212, the driver can issue a prefetch 214 instruction to load the header into the processor's cache (e.g., by using the packet descriptor's header address). Potentially, the packet may then be indicated to the protocol stack. Alternately, however, the driver may defer immediate indication and, instead, build an array of packets to indicate to the stack in a batch. For example, as shown, the driver may add 216 the packet's header to an array and only indicate 220 the array to the stack if 216 some threshold number of packets have be added to the array or if some threshold period of time has elapsed since indicating a previous batch of packets. Since prefetching data into the cache into memory takes some time, moderating indication to the stack increases the likelihood that prefetching completes for several packet headers before the data is needed. Depending on the application, it may also be possible to speculatively prefetch some of the payload data before the payload is accessed by the application.

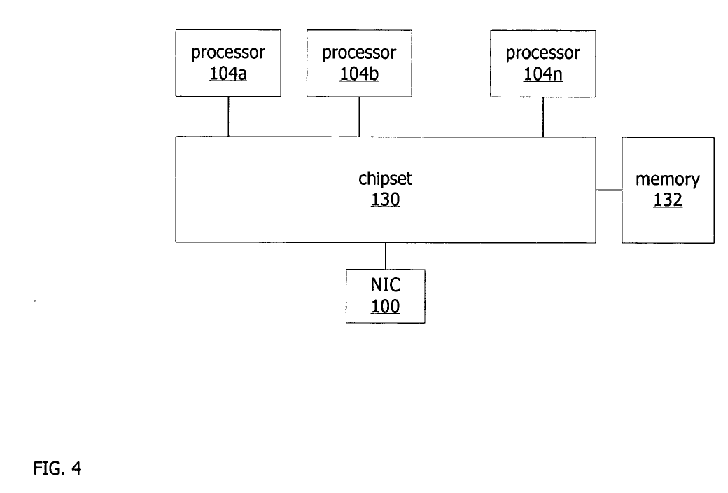

FIG. 4 illustrates a sample computer architecture that can implement the techniques described above. As shown, the system includes a chipset 130 that couples multiple processors 104a-104n to memory 132 and network interface controller 100. The processors 104a-104n may include one or more caches. For example, a given processor 104a-104n may feature a hierarchy of caches (e.g., an L2 and L3 cache). The processors 104a-104n may reside on different chips. Alternately, the processors 104a-104n may be different processor cores 104a-104n integrated on a common die.

The chipset 130 may interconnect the different components 100, 132 to the processor(s) 104a-104n, for example, via an Input/Output controller hub. The chipset 130 may include other circuitry (e.g., video circuitry and so forth).

As shown, the system includes a single network interface controller 100. However, the system may include multiple controllers. The controller(s) can include a physical layer device (PHY) that translates between the analog signals of a communications medium (e.g., a cable or wireless radio) and digital bits. The PHY may be communicatively coupled to a media access controller (MAC) (e.g., via a FIFO) that performs “layer 2” operations (e.g., Ethernet frame handling). The controller can also include circuitry to perform header splitting.

Many variations of the system shown in FIG. 4 are possible. For example, instead of a separate discrete network interface controller 100, the controller 100 may be integrated within the chipset 130 or a processor 104a-104n.

While the above described specific examples, the techniques may be implemented in a variety of architectures including processors and network devices having designs other than those shown.

While implementations were described above as software or hardware, the techniques may be implemented in a variety of software and/or hardware architectures. For example, driver or protocol stack operation may be implemented in hardware (e.g., as an Application-Specific Integrated Circuit) rather than in software. Similarly, while the above description described software prefetching by a driver, such prefetching may also/alternately be initiated by a hardware prefetcher operating on the processor or controller.

The term circuitry as used herein includes hardwired circuitry, digital circuitry, analog circuitry, programmable circuitry, and so forth. The programmable circuitry may operate on executable instructions disposed on an article of manufacture (e.g., a type of Read-Only-Memory such as a PROM (Programmable Read Only Memory or a computer readable medium such as a hard disk or CD (Compact Disk)). The term packet can apply to IP (Internet Protocol) datagrams, TCP (Transmission Control Protocol) segments, ATM (Asynchronous Transfer Mode) cells, Ethernet frames, among other protocol data units.

Other embodiments are within the scope of the following claims.

What is claimed is:

1. A method, comprising:
causing the header of the packet to be stored in a set of at least one page of memory allocated to storing packet headers; and
causing a payload of the packet to be stored in a location not in the set of at least one page of memory allocated to storing packet headers.

2. The method of claim 1,
wherein the packet comprises a Transmission Control Protocol/Internet Protocol (TCP/IP) packet.

3. The method of claim 1,
further comprising receiving the packet at a network interface controller having a media access controller (MAC) and physical layer device (PHY); and
wherein the causing the header to be stored comprises a direct memory access (DMA) to memory from the network interface controller.

4. The method of claim 1,
further comprising receiving a descriptor identifying a first memory location to store the header and a second memory location to store the payload.

5. A method, comprising:
issuing a cache prefetch instruction to access a packet header stored within a set of at least one page allocated to storing packet headers separately from their respective packet payloads.

6. The method of claim 5,
further comprising performing a memory operation to load the page into a translation lookaside buffer of the processor.

7. The method of claim 5,
further comprising preparing a descriptor identifying a first memory location to store the packet header and a second memory location to store the packet payload.

8. The method of claim 5,
further comprising receiving an interrupt from a network interface controller; and
wherein the issuing a prefetch instruction comprises issuing the prefetch instruction after the receipt of the interrupt.

9. The method of claim 5,
further comprising maintaining a set of entries for received packets; and
issuing a prefetch instruction for multiple ones of the entries.

10. A network interface controller, comprising:
at least one physical layer device (PHY);
at least one media access controller (MAC);
the controller comprising circuitry to:
determine the start of a packet header;
determine the start of the packet payload;
cause the packet header to be stored in a set of at least one page of memory allocated to storing packet headers; and
cause the packet payload to be stored in a location not in the set of at least one page of memory allocated to storing packet headers.

11. The controller of claim 10,
wherein the packet comprises a Transmission Control Protocol/Internet Protocol (TCP/IP) packet.

12. The controller of claim 10,
wherein causing the packet header to be stored comprises causing a direct memory access (DMA) to memory.

13. The method of claim 10,
further comprising circuitry to receive a descriptor identifying a first memory location to store the header and a second memory location to store the payload.

14. A computer system, comprising:
at least one processor, the at least one processor comprising at least one cache and a translation lookaside buffer;
memory communicatively coupled to the at least one processor;
at least one network interface controller communicatively coupled to the at least one processor; and
computer executable instructions disposed on an article of manufacture, the instructions to cause the at least one processor to issue a cache prefetch instruction to access a packet header stored within a set of at least one page allocated to storing packet headers separately from their respective packet payloads.

15. The system of claim 14,
wherein the instructions comprise instructions to perform a memory operation to load the page into the translation lookaside buffer of the processor.

16. The system of claim 14,
wherein the instructions comprise instructions to prepare a descriptor identifying a first memory location to store the packet header and a second memory location to store the packet payload.

17. The system of claim 14, wherein the instructions comprise instructions to:
maintain a set of entries for received packets; and
issue a prefetch instruction for multiple ones of the entries before indicating the set of entries.

18. An article of manufacture having computer executable instructions to cause a processor to:
issue a cache prefetch instruction to access a packet header stored within a set of at least one page allocated to storing packet headers separately from their respective packet payloads.

19. The article of claim 18,
wherein the instructions comprise instructions to perform a memory operation to load the page into a translation lookaside buffer of the processor.

20. The article of claim 18,
wherein the instructions further comprise instructions to prepare a descriptor identifying a first memory location to store the packet header and a second memory location to store the packet payload.

21. The article of claim 18, wherein the instructions further comprise instructions to:
maintain a set of entries for received packets; and
issue a prefetch instruction for multiple ones of the entries before indicating the set of entries.
